(19) United States
(12) Patent Application Publication
(10) Pub. No.: US 2024/0198404 A1
(43) Pub. Date: Jun. 20, 2024

(54) Drill Bit Straightening System

(71) Applicant: Marmon Holdings, Inc., Chicago, IL (US)

(72) Inventors: Jason SMID, Chicago, IL (US); Joseph MULLENBACH, Chicago, IL (US)

(73) Assignee: Marmon Holdings, Inc., Chicago, IL (US)

(21) Appl. No.: 18/390,305

(22) Filed: Dec. 20, 2023

Related U.S. Application Data
(60) Provisional application No. 63/433,959, filed on Dec. 20, 2022.

(51) Int. Cl. B21D 3/16; B23B 51/00

(52) U.S. Cl. CPC B21D 3/16; B23B 51/00; B23B 2260/092; B23B 2260/128; B23B 2270/48

(57) ABSTRACT

A system configured to automatically straighten a drill bit to within acceptable specifications is described herein. The drill bit straightening system described herein may include a drill bit holding assembly configured to hold a drill bit, one or more sensors configured to measure edge eccentricity of a shaft associated with the drill bit, a control unit configured to automatically control a straightening operation of the drill bit straightening system, and a drill bit pressing arm configured to straighten the drill bit by applying a force calculated based on one or more predictive models. The control unit may be configured to calculate force(s) to be applied to the drill bit using one or more predictive models.

### RELATED APPLICATIONS

This application claims priority to U.S. Provisional Patent Application No. 63/433,959, filed Dec. 20, 2022, the content of which is incorporated herein by reference in its entirety.

### FIELD OF THE INVENTION

The present invention relates to the metal device manufacture and, more particularly, to system and accompanying methods for straightening medical drill bits and other slender shafts to within allowable standards.

### BACKGROUND OF THE INVENTION

Medical drill bits are critical components in most surgical procedures including, for example, dental and orthopedic surgical procedures. Medical drill bits are durable uniformly distributed drill bits, typically made of stainless steel. They must be able to provide adequate force to cut into dense parts of human body, such as teeth or bone, until they reach the intended surgical site. The structural integrity of the drill bit is essential to the overall success of any surgical procedure.

Drill bits often become bent during manufacturing and/or transportation. For example, drill bits can become “bent” or “warped” at one or more points along their length. If they are bent or warped to the point that they fall outside of allowable surgical standards, they become unfit for use. The conventional method used to straighten a bent drill bit relies on the judgement of a human operator to determine the angle and force required to bend the drill back within allowable standards. Because such methods rely on the effort of a human operator, these methods can be both time and cost intensive. Finding and hiring such sufficiently skilled operators can also itself be both time and cost intensive.

Similar problems are encountered in other applications where slender shafts are required to be straightened to within some specific allowable standard. Accordingly, there is a need for improved systems and methods for efficiently and accurately straightening slender shafts (e.g., medical drill bits) to within allowable standards.

### SUMMARY OF THE INVENTION

Aspects of this disclosure relate to a system configured to automatically straighten a drill bit to within acceptable specifications. In various embodiments, the drill bit straightening system may comprise at least a mounting frame, a drill bit holding assembly configured to hold a drill bit, one or more sensors, a drill bit pressing arm installed on the mounting frame, a control unit, and/or one or more other components. In various embodiments, the drill bit holding assembly may be configured to hold the drill bit proximately at one end of the drill bit, forming a cantilever connection between the drill bit holding assembly and the drill bit. In some embodiments, the drill bit holding assembly may comprise a large top wheel that opens and allows the drill bit to be set into a valley formed by two lower wheels. In some embodiments, the large top wheel of the drill bit holding assembly is configured to close and clamp on the drill bit, forming the cantilever connection between the drill bit holding assembly and the drill bit. In some embodiments, the drill bit holding assembly may be configured to secure and support the drill bit at multiple locations along the drill bit. In various embodiments, the one or more sensors may be included within edge eccentricity measuring module(s) and are measure edge eccentricity of a shaft associated with the drill bit. In some embodiments, the one or more sensors are configured to measure a warp horizontally in the drill bit without contacting the drill bit. In various embodiments, the one or more sensors are configured to measure a distance between an outer surface of the drill bit and a center axis of the drill bit.

According to one or more aspects of this disclosure, a control unit of the drill bit straightening system described herein may be configured to automatically control a straightening operation of the drill bit straightening system. In various embodiments, the control unit may be configured to calculate a force to be applied to the drill bit to straighten the drill bit to within acceptable standards, for example, using one or more predictive models. In some embodiments, to calculate the force to be applied to the drill bit, the control unit may be configured to calculate a bending moment along a length of the drill bit based on a distance between the outer surface of the drill bit and a center axis of the drill bit measured by the one or more sensors. As described herein, the control unit may be configured to calculate one or more forces to be applied to the drill bit using a historical prediction model and/or a bitwise prediction model. In addition to information obtained from the one or more sensors, the control unit (or the prediction models) may use additional information to calculate a force to be applied to the drill bit, such as an overall spine shape, a force versus displacement curve determined during a bending operation, lot or batch specific information, and/or other information.

According to one or more aspects of this disclosure, the drill bit pressing arm of the drill bit straightening system described herein may be configured to straighten the drill bit by applying a force calculated by the control unit (e.g., using on one or more predictive models). In some embodiments, the drill bit pressing arm may be configured to apply a shear force at an end of the drill bit opposite an end of the drill bit secured by the drill bit holding assembly. In some embodiments, the drill bit pressing arm may be configured to apply the force at a distance from the drill bit holding assembly along the drill bit. For example, in some embodiments, the distance from the drill bit holding assembly may be pre-determined, and the control unit may be configured to calculate the force be applied to the drill bit based on the pre-determined distance from the drill bit holding assembly along the drill bit at which the force is to be applied. In other embodiments, the control unit may be configured to calculate the distance from the drill bit holding assembly along the drill bit at which to apply the force. In some embodiments, the drill bit pressing arm may be configured to apply the force to the drill bit in a uniformly distributed load along a length of the drill bit. In some embodiments, after a force is applied to the drill bit by the drill bit pressing arm, the control unit may be configured to determine whether the drill bit is within an acceptable specification range and calculate a second force to be applied to the drill bit if the drill bit is not within the acceptable specification range after applying the force. The drill bit straightening system may continue these operations until the drill bit is within an acceptable specification range.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example drill bit straightening system, according to one or more aspects described herein;

FIG. 2 depicts a perspective view of an example drill bit, according to one or more aspects described herein;

FIG. 3A depicts a perspective view of an example drill bit straightening system, according to one or more aspects described herein;

FIGS. 3B-3H depict various views of an example drill bit pressing arm of a drill bit straightening system, according to one or more aspects described herein;

FIG. 4 depicts a block diagram of an example drill bit straightening system configured to utilize a prediction algorithm, according to one or more aspects described herein;

FIG. 5 illustrates an example of a process for straightening a drill bit using an adaptive prediction algorithm, according to one or more aspects described herein; and

FIG. 6 depicts a graph including prediction and results of an example of a drill bit straightening system configured using a prediction algorithm, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

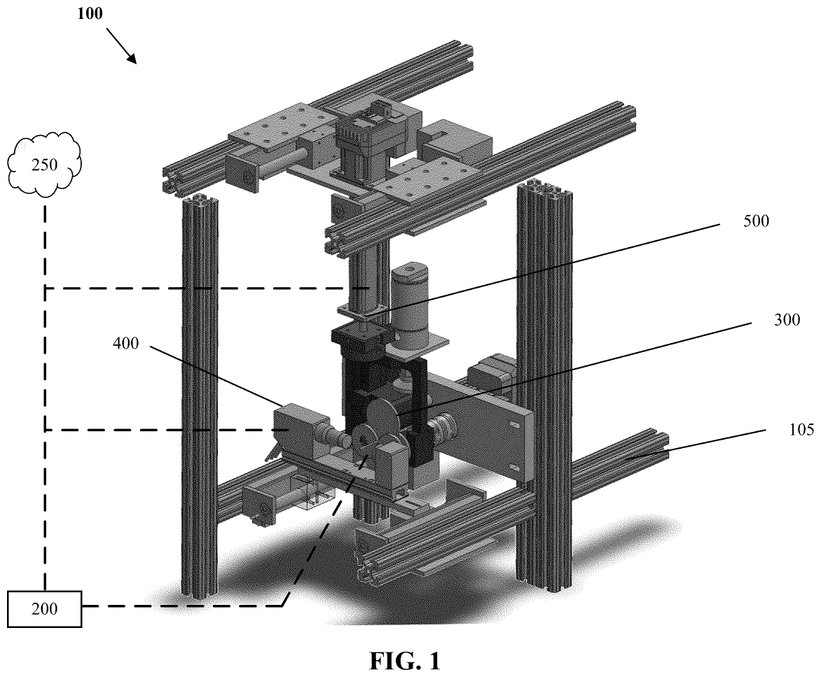

FIG. 1 depicts a perspective view of a drill bit straightening system 100, according to one or more aspects described herein. Drill bit straightening system 100 is described herein as a system for straightening medical drill bits. However, drill bit straightening system 100 (or one or more components or features of drill bit straightening system 100) may also be used to straighten other slender shafts for other applications, inside or outside the medical industry. As depicted in FIG. 1, drill bit straightening system 100 may comprise a control unit 200, a drill bit holding assembly 300, one or more edge eccentricity measuring modules 400, a drill bit pressing arm 500, and/or one or more other components installed on or otherwise located proximate to mounting frame 105.

In various embodiments, control unit 200 may include one or more processors configured to provide information processing capabilities in drill bit straightening system 100. The one or more processors may comprise one or more of a digital processor, an analog processor, a digital circuit designed to process information, a central processing unit, a microcontroller, an analog circuit designed to process information, and/or other mechanisms for electronically processing information. In various embodiments, one or more processors of control unit 200 may be configured to execute computer-readable instructions stored in electronic storage of control unit 200. As used herein, for convenience, drill bit straightening system 100 will be described as performing various operations, when, in fact, computer readable instructions may program one or more processors of control unit 200 to perform the various operations described herein.

In various embodiments, the one or more processors of control unit 200 may be configured to receive input from one or more components of drill bit straightening system 100 and provide various outputs based on the input received. For example, control unit 200 may be configured to cause drill bit holding assembly 300 to provide input or instructions to cause one or more actions associated with a drill bit as described herein, relay information to one or more other remote entities 250 (e.g., a local data server, or a cloud database), and/or other outputs.

In various embodiments, drill bit holding assembly 300, one or more edge eccentricity measuring modules 400, drill bit pressing arm 500, and/or other components of drill bit straightening system 100 may be communicatively connected to control unit 200. In various embodiments, drill bit holding assembly 300 (and drill bit straightening system 100) may be configured to communicate with the remote entities 250. For example, remote entities 250 may be connected via a wired and/or wireless network and configured to communicate with control unit 200 and/or one or more other components of drill bit straightening system 100.

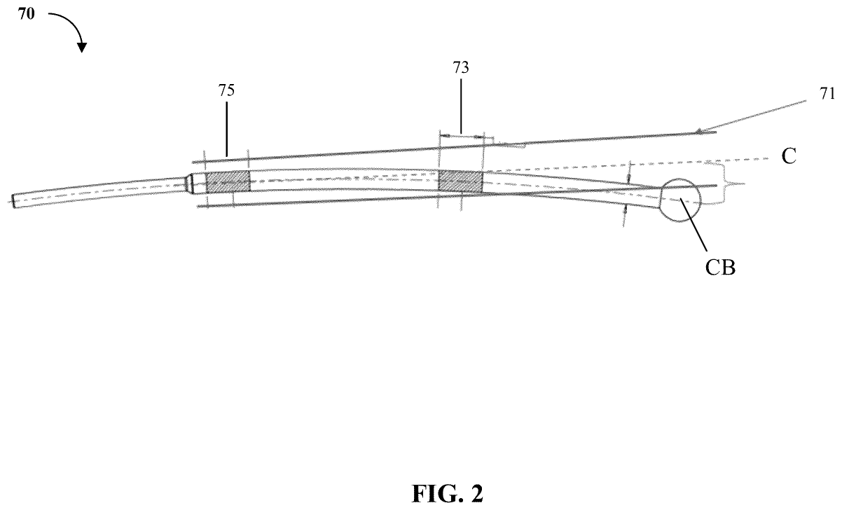

FIG. 2 depicts a perspective view of a drill bit 70, according to one or more aspects described herein. As shown in FIG. 2, a bit 70 can have a bend portion about a first end of the bit (“bent portion” 73) extending for a distance of the length of the bit 70. Similarly, the same bit 70 can have a straight portion 75 of the bit 70. The extending line 71 indicates the acceptable boundaries (TRO). The straight portion 75 of bit 70 has a center axis C and the bent portion 73 of bit 70 has a bent center axis CB that is not equal to the center axis C of the straight portion 75 of bit 70. The difference between the center axis C and the bent center axis CB can be referred to as the “indicated displacement” or “radial difference.”

There are many possible reasons for a bit 70 to become bent. Medical drill bits are often made of material that is uniformly distributed throughout the drill bit. Typically, drill bits are made of stainless steel, using, for example, a Swiss lathe and with single pass machining. This typically results in fast cycle times and good diametrical accuracy. However, in various cases, residual stresses in the drill bit can cause it to bend or warp into a banana shape after the machining operation is complete. Due to the single pass machining process, it may not be possible to cut away the warped portions. In such case, the bit must be loaded in a tool or system that can bend and yield bit 70 into the desired final shape.

It is not possible to know the residual stress state of the drill bit at any point. Further the residual stress distribution inside the drill bit can and/or does change over time (i.e., typically a time period of years). The only observations which can be made are the initial state of the drill bit prior to machining and the final state of the bit after machining. Both of these states represent the summation of all individual residual stress states inside the drill bit. Moreover, residual stress states inside the drill bit may affect the stress/strain response. Since these states cannot be known individually it is impossible to form a useful prediction algorithm by knowing only the initial conditions.

It is one benefit of this invention to straighten bent portion 73 of bit 70 so that the bent center axis CB can be made the same as the center axis C of the straight portion 75. Each bit may be unique, whereby the angle of bend and bending force may differ from one bit to the next. As such, drill bit straightening system 100 is able accommodate these variations to provide the desired results.

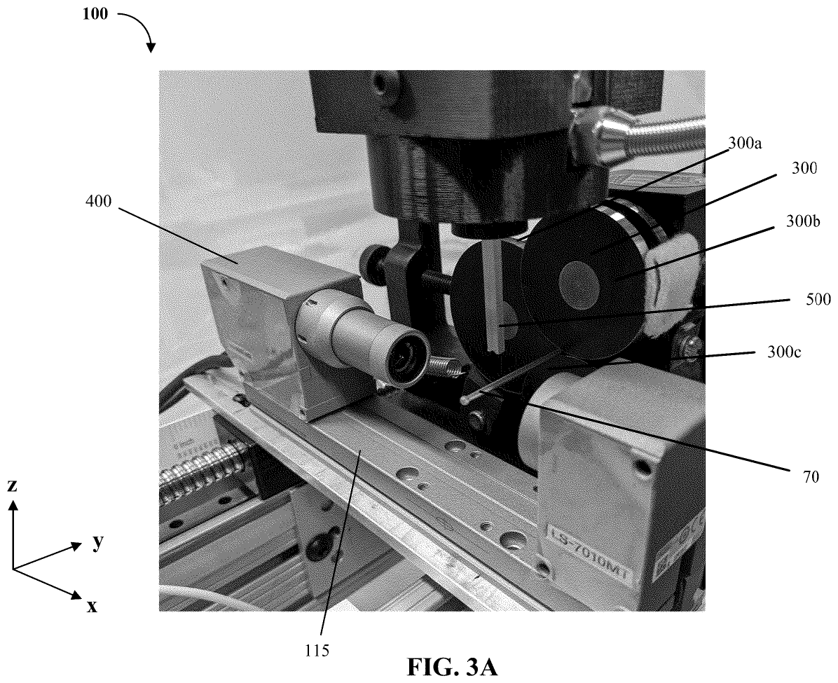

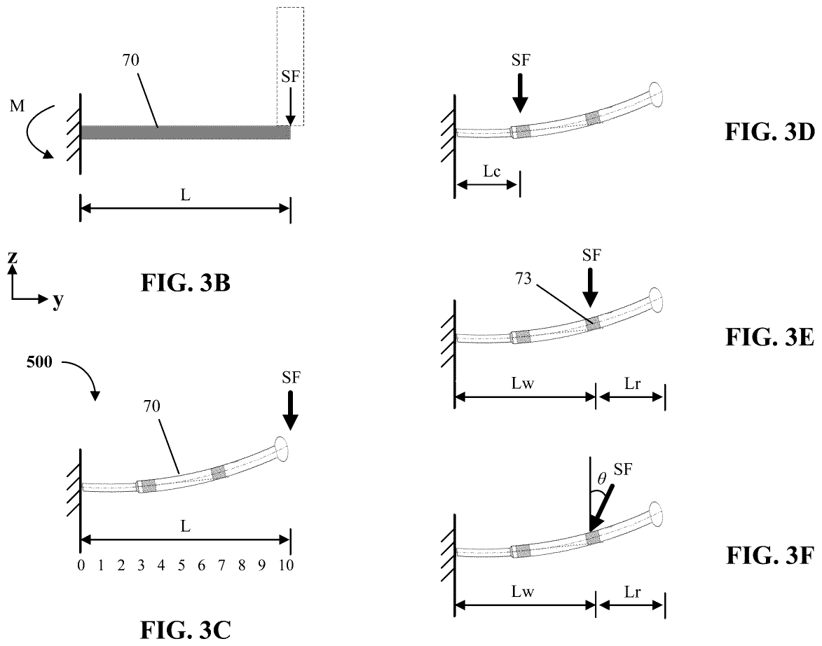

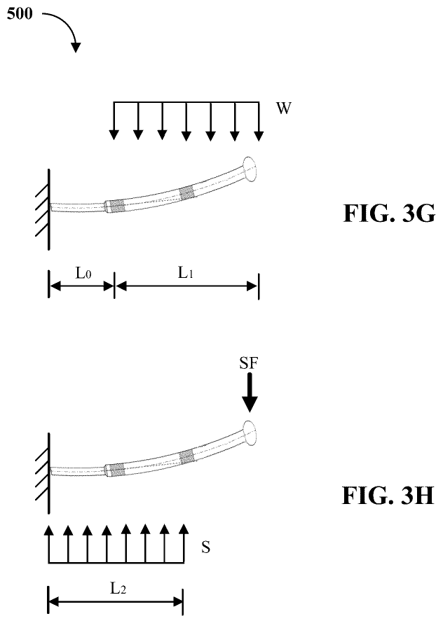

As depicted in FIG. 3A, drill bit straightening system 100 may be configured to measure a warp horizontally and without physically contacting drill bit 70. As also depicted in FIG. 1, drill bit 70 may be mounted to a drill bit holding assembly 300 located on a drill bit holding plane (i.e., x-z plane) and rotates along a drill bit rotating axis (i.e., y axis). In some embodiments, drill bit holding assembly 300 may include a securing mechanism, for example, by the one or more spindle rollers 300a, 300b, 300c, such as “St. Marie's spin roll.” In various embodiments, drill bit holding assembly 300 may include a large top wheel that opens and allow drill bit to be set into the valley, which is formed by two lower wheels. Then, the top wheel closes and clamp the bit securely in place, effectively forming a cantilever beam connection. In various embodiments, drill bit straightening system 100 may utilize the clamping method described above (e.g., drill bit holding assembly 300 having a large top wheel and two lower wheels) and/or one or more other types of clamping methods. For example, a three-jaw chuck and/or one or more other types of clamping mechanisms now known or future developed may be utilized with the systems and methods described herein. In some embodiments, the axis alignment can be accomplished by properly positioning spindle rollers 300a, 300b, 300c so that the center axis C of the straight portion 75 of bit 70 is aligned along a predetermined center axis (i.e., y axis) of the drill bit straightening system 100. In some embodiments, the drill bit may extend a sufficient length from the clamping location, depending on product length and specific configuration of the system. The cantilever beam connection (or configuration) may concentrate the stress such that the bending is at or proximate to the clamping location, regardless of where the pressing arm “pusher” is located. However, multiple bending locations can be achieved by loading the part at different positions, putting the clamping wheels where it is desired to bend the part.

In various embodiments, one or more edge eccentricity measuring modules 400 of drill bit straightening system 100 may be configured to measure distances of the outer surface of the drill bit from the center axis C, as depicted in FIG. 2. In various embodiments, the one or more edge eccentricity measuring modules 400 may include one or more sensors configured to measure the deformation or bend in a drill bit. For example, one or more sensors of edge eccentricity module(s) 400 may be configured to measure edge eccentricity of a shaft associated with the drill bit. In some embodiments, one or more edge eccentricity measuring modules 400 may include a laser micrometer. A warped drill bit will not have all points of the circumference at equal distances (same radius value) from the center axis C of bit 70. Rather, a particular portion of the circumference of the drill bit will have a greater distance H (“highest point”) from the center axis C, while an opposing section of the circumference of the drill bit will have a lesser distance H′ (“lowest point”) from the center axis C. The measurements taken by the one or more edge eccentricity measuring modules 400, including the distance H for the entire circumference of the bit 70, can then be used to calculate the radial difference.

In various embodiments, one or more edge eccentricity measuring modules 400 may be configured to be mounted to a base frame 115 generally perpendicular to the drill bit holding plane (i.e., x-z plane) and generally perpendicular to a pressing axis (i.e., z axis) that the drill bit pressing arm 500 travels along. In various embodiments, one or more edge eccentricity measuring modules 400 may be positioned adjacent to or otherwise in close proximity to drill bit 70 while also allowing to move and change a distance from the drill bit 70 between positions.

In various embodiments, drill bit pressing arm 500 may include a linear actuator with closed loop position functionality. In some embodiments, drill bit pressing arm 500 disclosed herein may include drill bit pressing arm force sensor 502. For example, a drill bit pressing arm force sensor 502 may be an in-line load cell. In various embodiments, drill bit pressing arm 500 may be positioned linearly along the drill bit to apply pressure in different locations.

In some embodiments, the bit 70 may not be “straightenable” because the initial runout is too high. To address this situation, bit 70 may be straightened by drill bit straightening system 100 by utilizing multiple clamping zones as described herein. In one example embodiment, drill bit straightening system 100 may utilize multiple clamping zones by securing and support the drill bit at multiple locations along the drill bit. Ultimately, to allow for an initial condition in which bit 70 has a higher runout, drill bit straightening system 100 may be configured to straighten bit 70 by performing the operations described herein at multiple bending locations.

Some previous operations/methods include an analog measurement by manual process. For example, the operation may choose the bending plane according to the angle at which the edge measurement is maximum. In such a case, previous operations/methods rotate until the “high spot” is found and press the bit at the “high spot.” However, this type of operation may be prone to and/or sensitive to the measurement noise and the surface texture. In some cases, pushing on the “high spot” at the measurement location may result in increasing the eccentricity, and further warping, rather than straightening the central bit axis. Particularly, this is important since the total indicated runout (edge eccentricity)-that is, the maximum runout (edge eccentricity) along the length of the shaft, not just at a single measurement location-is the desired tolerance.

FIGS. 3B-3H depict various views of an example drill bit pressing arm 500 of drill bit straightening system 100, according to one or more aspects described herein. In various embodiments, as depicted in FIG. 3B, drill bit pressing arm 500 of drill bit straightening system 100 may be configured to calculate parameters such as (i) shear force (SF) to be applied (along a pressing axis, i.e., the z-axis, at a distance L) onto a bit 70 and/or (ii) a bending moment M along a length of the bit 70 based on distances measured by one or more edge eccentricity measuring modules 400 of the outer surface of the drill bit from the center axis (i.e., center axis C, as depicted in FIG. 2). The shear force at any location along the bit can then be used to calculate the shear stress over the bit's cross section at that location.

As depicted in FIG. 3C, in some embodiments, drill bit straightening system 100 may be configured to apply shear force (SF) at the end, located at a distance L, of a “bent” or “warped” bit 70. In other embodiments, and as depicted in FIG. 3D, drill bit straightening system 100 may be configured to apply shear force (SF) at a distance Lc (from, at, or proximate to the clamping location) of a “bent” or “warped” bit. In yet other embodiments, and as depicted in FIG. 3E, drill bit straightening system 100 may be configured to apply shear force (SF) at a distance Lw (e.g., at a “bent portion” 73 of the drill bit) of a “bent” or “warped” bit. In other embodiments, and as depicted in FIG. 3F, drill bit straightening system 100 may be configured to apply shear force SF with an angle θ at a distance Lw (e.g., at a “bent portion” 73) of a “bent” or “warped” bit.

In some embodiments, and as depicted in FIG. 3G, drill bit straightening system 100 may be configured to apply uniformly distributed load/force W along a length L₁ of a “bent” or “warped” bit 70. In other embodiments, and as depicted in FIG. 3H, drill bit straightening system 100 may be configured to provide a uniformly distributed support/force S along a length L₂ underneath a “bent” or “warped” bit, when applying shear force SF at the end of a “bent” or “warped” bit.

Another aspect of the present disclosure is a capability of drill bit straightening system 100, and the corresponding methods described herein, to measure a warp and apply a calculated force to drill bit with a high degree of repeatability and accuracy, for example, due to the potential presence of heterogeneous residual stress within a drill bit 70. In various embodiments, drill bit straightening system 100 may be configured to utilize one or more prediction algorithm/components 600 and one or more bending or pressing algorithm/components 700 that can be applied to the drill bit pressing arm (“pusher”) force sensor 500, based on information from the one or more edge eccentricity measuring modules 400 and/or other sensors of drill bit straightening system 100.

In various embodiments, eccentricity data (i.e., radial distance of the bit 70 from the center axis C) generated by the one or more edge eccentricity measuring modules 400 may be fed into a curve-fitting component (algorithm). For example, in some embodiments, the curve fitting component may be configured to receive the eccentricity data and apply a curve-fitting algorithm on to the eccentricity data based on sinusoidal curve such as a sine function (curve) with a period of one full rotation (i.e., at the angle of 0 degrees and continue for a full (360 degree) rotation). Because the eccentricity of the measurement data results in a sine function when measured at the edge, this curve-fitting component has an effect of separating a portion of the runout (edge eccentricity) that can be corrected by straightening from the portion that cannot. As the straightening operation continues, the eccentricity component goes to zero, while the surface roughness and diametrical variation do not. Particularly, this may be more important as a signal of when to stop the procedure. If the eccentricity component has reached zero, further press/bending force may have the effect of increasing, rather than decreasing indicated runout (edge eccentricity).

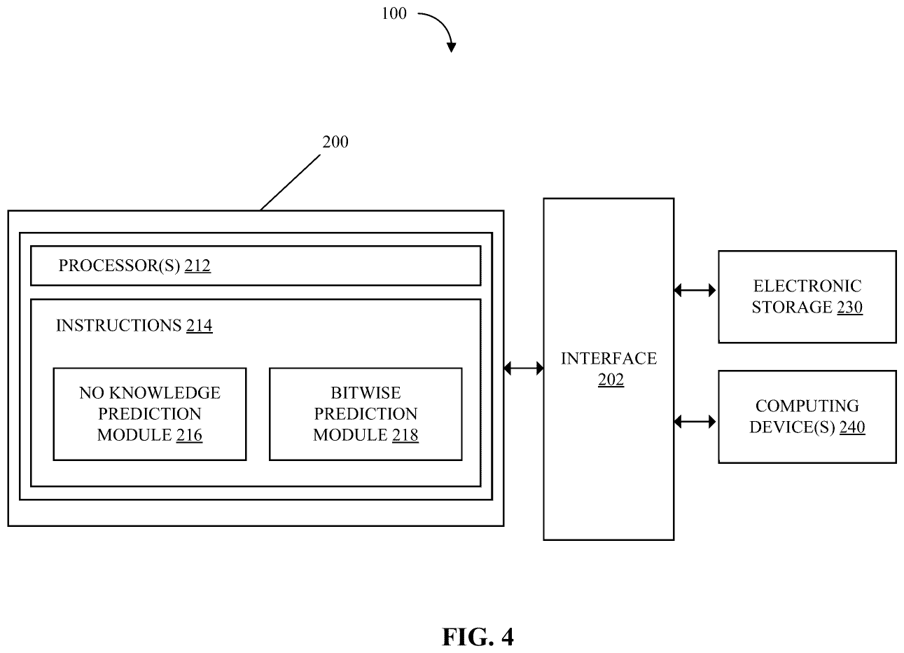

FIG. 4 illustrates an example of a drill bit straightening system 100 for measuring a warp and apply a calculated force to drill bit using prediction and bending algorithm, according to one or more aspects described herein. In various implementations, drill bit straightening system 100 may include a control unit 200, one or more interfaces 202, an electronic storage 230, and/or one or more other components. In various implementations, control unit 200 may include one or more physical processors 212 (also interchangeably referred to herein as processor(s) 212, processor 212, or processors 212 for convenience), computer readable instructions 214, and/or one or more other components. In various implementations, drill bit straightening system 100 may be configured to receive input from or otherwise interact with one or more users via one or more computing device(s) 240.

### Prediction Algorithm

### (i) Historical Prediction Model—Bayesian Prior (“No-Knowledge Predictor”)

In various implementations, no-knowledge predictor module 216 may be configured to produce original eccentricity data representing a zero eccentricity or perfectly straightened based on the empirical data 590 (also referred to herein as “historical data”). In such implementations, no-knowledge predictor module 216 may be configured to obtain empirical data 590 collected from prior straightening operations. In various embodiments, the empirical data 590 may comprise data collected from one or more edge eccentricity measuring modules 400 and a drill bit pressing arm 500.

Then, no-knowledge predictor module 216 may be configured to apply or perform curve fitting operation to interpolate or extrapolate the forces at which one particular bit was corrected to a percent of its original eccentricity. For example, no-knowledge predictor module 216 may perform curve fitting operations using an exponential function. In addition, no-knowledge predictor module 216 may perform curve fitting operations using various functions including, for example, a linear function, logarithmic function, quadratic function, cubic function, square root function, power function, polynomial function, rational function, exponential function, sinusoidal function, and/or variations or combinations thereof. For example, in some embodiments, an estimative algorithm may comprise a linear function component which is accorded a first weight w1, a logarithmic function component which is accorded a second weight w2, and an exponential function component which is accorded a third weight w3. In further embodiments, the weights associated with each component may vary as a function of shear force applied and/or other parameters, but in an alternative embodiment, one or more of these weights are constant as a function of shear force applied. In various embodiments, curve fitting operations may be performed using one or more of various curve fitting techniques including, for example, linear least squares fitting method, non-linear least squares fitting method, Nelder-Mead Simplex method, Levenberg-Marquardt method, and/or variations thereof.

In various implementations, no-knowledge predictor module 216 may be configured to gather a collection of starting eccentricity and 100% corrective force data points 610. In some embodiments, a regression may be performed on these data to predict the expected value at any given starting eccentricity, along with the expected distribution.

Given no individual knowledge of the bit beyond its starting eccentricity, this provides a prediction of final shear force to be applied as well as an expected range of values. This method is additionally used to determine the distribution of values corresponding to a smaller percentage of full correction, which is useful for predicting a force that will provide enough bending to model the individual bit. In such implementations, the curve-fitting operation provides an updated prediction of total force required to straighten the drill bit.

### (ii) Individual Bit Prediction Model (“Bitwise”)

In various implementations, a bitwise module 218 may be configured to use the same exponential model. Then, three (3) data points are generated using the no-knowledge predictor module 216 to partially bend the bit. In some implementations, the no-knowledge predictor module 216 and the bitwise prediction module 218 may use convolution to generate a new model which can be used to predict the force value which would result in an in-spec drill bit.

### Bending Algorithm

In some implementations, the drill bit straightening system 100 may choose the next bending force independent of previously described predictive models. In such cases, the models may be used differently. For example, in some implementations, the bitwise prediction module 218 may produce a final force that is outside of the acceptable range and the no-knowledge predictor module 216 produce a prediction (i.e. 3 standard deviations above the mean). In such cases, drill bit straightening system 100 may reject the no knowledge prediction data. In other implementations, the bitwise prediction module 218 may produce very lightly weighted prediction, for example, within 5-10%, compared to the no knowledge prediction.

In various implementations, drill bit straightening system 100 may be configured to avoid bending past zero eccentricity, because it may results in unwanted results of increasing eccentricity in the opposite direction. In particular, this is not easily corrected by “bending back” because the bending force required in one direction is not predictive of the bending force required in another direction, even the direct reverse direction. Therefore, the predictors can be used to determine a conservative approach unlikely to overbend. As confidence in the model increases, the conservatism can be relaxed.

In general, combining predictions gathered from different information sources, and weighting them according to the relative confidence in those predictions is a process of Bayesian inference. Accordingly, the prediction is updated continuously as additional information becomes known. Furthermore, additional sources of information may be included in the prediction, such as the overall spine shape, the force versus displacement curve during a bending operation, or lot or batch specific information to name a few.

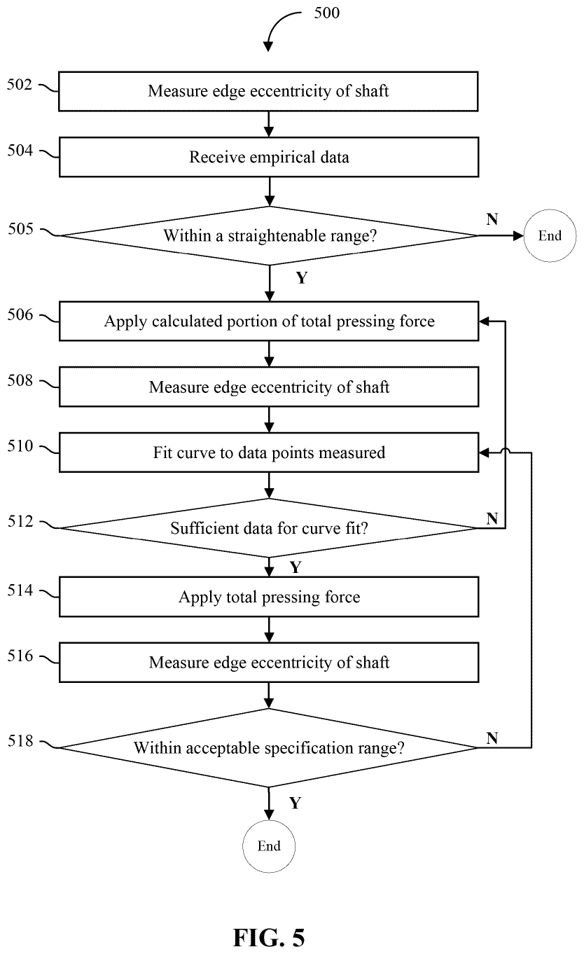

FIG. 5 illustrates an example of a process 500 for straightening a drill bit using adaptive prediction algorithm, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above. In various embodiments, process 500 may be performed using some or all of the components of drill bit straightening system 100 described herein. For example, the functionality described with respect to process 500 may be performed by a control unit 200 of drill bit straightening system 100.

In an operation 502, process 500 may include measuring an initial edge eccentricity of a shaft associated with a drill bit. In various embodiments, one or more edge eccentricity measuring modules 400 of drill bit straightening system 100 may be configured to measure distances of the outer surface of the drill bit from the center axis C, as depicted in FIG. 2. In some embodiments, one or more edge eccentricity measuring modules 400 may include one or more laser micrometers. In some embodiments, the measure distances of the outer surface of the drill bit from the center axis C may be stored as historical data in response to a determined prediction model.

In an operation 504, process 500 may include receiving empirical data collected from multiple straightening operations in the past. In various embodiments, the empirical data may comprise data collected from one or more edge eccentricity measuring modules 400 and a drill bit pressing arm 500. In various embodiments, the one or more other measuring sensors may be installed on or adjacent to the mounting frame at a location from the drill bit.

In an operation 505, process 500 may include determining whether the initially measured edge eccentricity is within a straightenable range. In some embodiments, a warped drill bit may not be “straightenable” because an initial runout is too high (or out of range). In such embodiments, process 500 may reject the bit 70 from the operation. In other embodiments, a warped drill bit may not be “straightenable” because an initial runout is not balanced. In such embodiments, the bit 70 may yet be straightened by drill bit straightening system 100 by utilizing multiple clamping zones, as described herein. To allow for an initial condition in which bit 70 includes an unbalanced runout, drill bit straightening system 100 may be configured to straighten bit 70 by performing the operations described herein at multiple bending locations.

In an operation 506, process 500 may include calculating a portion of total pressing force based on the empirical data and applying calculated portion of total pressing force onto the drill bit. In some embodiments, a warped drill bit may not have all points of the circumference at equal distances, instead, original eccentricity of 1, 2, 4, 2, 1 and final eccentricity of 0, 1, 2, 1, 0 from the center axis C of bit 70 along a length L. For example, in such embodiments, process 500 may apply 4/10 (ΣOriginal eccentricity/ΣFinal eccentricity) of total pressing force onto the drill bit. As depicted in FIG. 3C, drill bit straightening system 100 may be configured to apply shear force SF at a distance L with 4/10 (ΣOriginal eccentricity/ΣFinal eccentricity) of total pressing force (i.e., 4/10×10 Newton (N)=4 N) at the end of a “bent” bit 70.

In an operation 508, process 500 may include measuring edge eccentricity of a shaft associated with a drill bit. In various embodiments, one or more edge eccentricity measuring modules 400 of drill bit straightening system 100 may be configured to measure again distances of the outer surface of the drill bit from the center axis C, as depicted in FIG. 2.

In an operation 510, process 500 may include performing curve fitting using the data points measured. In various embodiments, eccentricity data (i.e., radial distance of the bit 70 from the center axis C) generated by the one or more edge eccentricity measuring modules 400 may be fed into a curve-fitting component (algorithm). For example, in some embodiments, the curve fitting component may be configured to receive the eccentricity data and apply a curve-fitting algorithm on to the eccentricity data based on sinusoidal curve such as a sine function (curve) with a period of one full rotation (i.e., at the angle of 0 degrees and continue for a full (360 degree) rotation. Because the eccentricity of the measurement data results in a sine function when measured at the edge, this curve-fitting component has an effect of separating a portion of the runout (edge eccentricity) that can be corrected by straightening from the portion that cannot. As the straightening operation continues, the eccentricity component goes to zero, while the surface roughness and diametrical variation do not. Particularly, this may be more important as a signal of when to stop the procedure. If the eccentricity component has reached zero, further press/bending force may have the effect of increasing, rather than decreasing indicated runout (edge eccentricity).

In an operation 512, process 500 may include determining whether the measured data has sufficient data points for the curve-fitting. If it is determined that measured data has sufficient data points for the curve-fitting, process 500 will proceed to the operation 514. If it is determined that measured data does not have sufficient data points for the curve-fitting, process 500 will go back to operation 506, and apply newly calculated portion of total pressing force onto the drill bit based on the new data points measured.

In an operation 514, process 500 may include calculating a total pressing force based on additional data, and may include applying the total pressing force onto the drill bit. Particularly, in comparison to the operation 506, process 500 is configured to apply total, 100%, of calculated pressing force.

In an operation 516, process 500 may include measuring edge eccentricity of a shaft associated with a drill bit. In various embodiments, one or more edge eccentricity measuring modules 400 of drill bit straightening system 100 may be configured to measure again distances of the outer surface of the drill bit from the center axis C, as depicted in FIG. 2.

In an operation 516, process 500 may include determining whether the total pressing force applied to the drill bit pressing arm 500 results in the movement of the drill bit within the acceptable specification range. If it is determined that the measured edge eccentricity of the drill bit is within the acceptable specification range, drill bit straightening system 100 may be configured to end the process 500. If it is determined that the measured edge eccentricity of the drill bit is not within the acceptable specification range, process 500 will go back to operation 510, where a newly fitted curve will be generated based on the new data points measured.

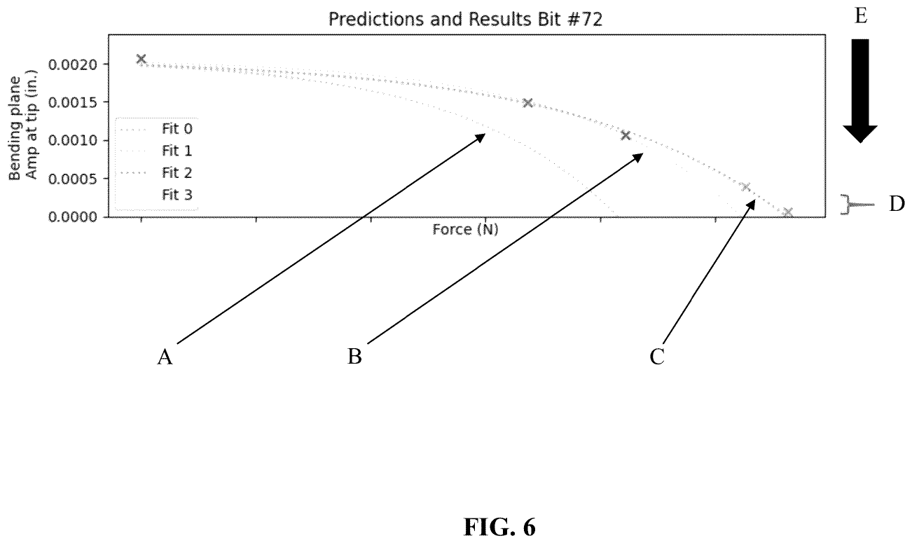

FIG. 6 depicts a graph including prediction and results of an example of a drill bit straightening system configured using prediction algorithm, according to one or more aspects described herein. The data point “A” (on the curve “Fit 0”) represents an initial prediction data based on pure trial without any prediction as described in operation 502, also depicted in FIG. 5. The data point “B” represents a partial force bent measurement using updated curve as described in operation 508. The data point “C” represents a final measurement of the result that is within the acceptable specification range “D” as described in operation 518. As shown in the direction by an arrow “E”, as the operation progress, the drill bit straightening system 100 increases straightness of the drill bit.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A drill bit straightening system comprising:
a mounting frame;
a drill bit holding assembly configured to hold a drill bit;
one or more sensors configured to measure edge eccentricity of a shaft associated with the drill bit;
a drill bit pressing arm installed on the mounting frame and configured to straighten the drill bit by applying a force calculated based on one or more predictive models; and
a control unit configured to automatically control a straightening operation of the drill bit straightening system based on the one or more predictive models.

2. The drill bit straightening system of claim 1, wherein the drill bit holding assembly is configured to hold the drill bit proximately at one end of the drill bit, forming a cantilever connection between the drill bit holding assembly and the drill bit.

3. The drill bit straightening system of claim 2, wherein the drill bit holding assembly comprises a large top wheel that opens and allows the drill bit to be set into a valley formed by two lower wheels.

4. The drill bit straightening system of claim 3, wherein the large top wheel of the drill bit holding assembly is configured to close and clamp on the drill bit, forming the cantilever connection between the drill bit holding assembly and the drill bit.

5. The drill bit straightening system of claim 1, wherein the drill bit holding assembly is configured to secure and support the drill bit at multiple locations along the drill bit.

6. The drill bit straightening system of claim 1, wherein the one or more sensors include a laser micrometer.

7. The drill bit straightening system of claim 1, wherein the one or more sensors are configured to measure a warp horizontally in the drill bit without contacting the drill bit.

8. The drill bit straightening system of claim 1, wherein the one or more sensors are configured to measure a distance between an outer surface of the drill bit and a center axis of the drill bit.

9. The drill bit straightening system of claim 8, wherein to calculate the force to be applied to the drill bit, the control unit is configured to calculate a bending moment along a length of the drill bit based on the distance between the outer surface of the drill bit and the center axis of the drill bit measured by the one or more sensors.

10. The drill bit straightening system of claim 1, wherein the control unit is configured to calculate the force to be applied to the drill bit using a historical prediction model.

11. The drill bit straightening system of claim 10, wherein the control unit is configured to calculate a second force to be applied to the drill bit using a bitwise prediction model.

12. The drill bit straightening system of claim 11, wherein the control unit is configured to calculate the second force to be applied to the drill bit using the bitwise prediction model and additional information, the additional information including one or more of an overall spine shape, a force versus displacement curve determined during a bending operation, and lot or batch specific information.

13. The drill bit straightening system of claim 1, wherein the drill bit pressing arm is configured to apply a shear force at an end of the drill bit opposite an end of the drill bit secured by the drill bit holding assembly.

14. The drill bit straightening system of claim 1, wherein the drill bit pressing arm is configured to apply the force at a distance from the drill bit holding assembly along the drill bit.

15. The drill bit straightening system of claim 14, wherein the distance is pre-determined, and wherein the control unit is configured to calculate the force be applied to the drill bit based on the pre-determined distance from the drill bit holding assembly along the drill bit at which the force is to be applied.

16. The drill bit straightening system of claim 14, wherein the control unit is configured to calculate the distance from the drill bit holding assembly along the drill bit at which to apply the force.

17. The drill bit straightening system of claim 1, wherein the drill bit pressing arm is configured to apply the force to the drill bit in a uniformly distributed load along a length of the drill bit.

18. The drill bit straightening system of claim 1, wherein the control unit is configured to determine whether the drill bit is within an acceptable specification range after applying the force and calculate a second force to be applied to the drill bit if the drill bit is not within the acceptable specification range after applying the force.
